(19) United States
(12) Patent Application Publication
(10) Pub. No.: US 2017/0330113 A1
(43) Pub. Date: Nov. 16, 2017

(54) PROJECT PROPOSAL BOOKLET

(71) Applicant: Lawrence M. JANESKY, Middlebury, CT (US)

(72) Inventor: Lawrence M. JANESKY, Middlebury, CT (US)

(21) Appl. No.: 15/663,006

(22) Filed: Jul. 28, 2017

Related U.S. Application Data
(63) Continuation of application No. 13/837,913, filed on Mar. 15, 2013.

(51) Int. Cl. G06Q 10/06; B42D 1/00

(52) U.S. Cl. CPC G06Q 10/06; B42D 1/009

(57) ABSTRACT

A project proposal booklet, including an index sheet having a proposal index thereon, the proposal index having a matrix of services, the matrix of services including at least one broad category of services, at least one specific service associated with a respective broad category of services, at least one specific service code and at least one price index, each of which are associated with a respective at least one specific service, at least one proposal sheet corresponding to one of the at least one specific service and the at least one specific service code associated with the one of the at least one specific service, the at least one proposal sheet includes a problem section, a solution section, and a unit of measure, the unit measure section further corresponding to the specific price index associated with the one of the at least one specific service.

### CROSS-REFERENCE TO RELATED APPLICATIONS

This application is a continuation of U.S. Non-Provisional patent application Ser. No. 13/837, 913, filed Mar. 15, 2013, the disclosure of which is incorporated herein by reference in its entirety.

### BACKGROUND

### 1. Field

The exemplary embodiments generally relate to contractual proposal order booklets and, more particularly, to contractual proposal order booklets covering products and services to be ordered by a customer and performed by a contractor or installer.

### 2. Brief Description of Related Developments

Generally, contractual proposal booklets are often used as sale or presentation aids used, for instance, in cases of repair or renovation of structures or sites. Typically, these proposal booklets identify a list of proposed repairs or remodeling tasks that are to be undertaken as part of a renovation proposal. These contractual proposal booklets may also be used to generate an estimate of costs involved in the performance of a renovation proposal.

However, generally, the contractual proposal booklets often have several disadvantages that render them more difficult to use for the customer as well as the contractor or installer. One such disadvantage is that often, the contractual proposal booklets are complicated and difficult to understand for lay customers. These contractual proposal booklets often lack clear explanations to the problems that a customer might have as they contemplate a renovation project. Further, these contractual proposal booklets do not typically give sufficient explanations for the solutions that may be undertaken to effect repair or remodeling as per a customer's demands and needs. The known contractual proposal booklets tend to leave consumers confused as to what specific problems they are trying to address and what solutions are available to them in considering a renovation project.

Further, the contractual proposal booklets are often designed in such a way that the calculation methodology for estimating the costs of a renovation proposal project is not immediately apparent. The customer is left at the mercy of the contractor or installer who may not explain the scope and specifics of a renovation proposal and how the costs associated with the renovation proposal are calculated. Additionally, the contractual proposal booklets tend to be difficult to customize or update for individual customers or for updated changes in pricing.

These issues may lead to customer confusion and misunderstanding as to the proposed renovation projects as well as costs. Further, these issues may also make it unduly difficult to estimate costs as well as make it difficult for the contractual proposal booklets to be updated easily.

It is desirable to provide a proposal booklet which will address the disadvantages identified above, specifically one that can clearly explain problems and potential solutions for the repair or renovation of structures or sites. Further, it is desirable to provide a proposal booklet that simplifies the calculation of costs for a repair or renovation project.

### BRIEF DESCRIPTION OF THE DRAWINGS

The foregoing aspects and other features of the disclosed embodiments are explained in the following description, taken in connection with the accompanying drawings, wherein:

FIG. 1 is a block diagram view of a proposal booklet in accordance with an aspect of the disclosed embodiment;

FIG. 2 is a plan view of a proposal index in accordance with an aspect of the disclosed embodiment;

FIG. 3 is a plan view of a proposal sheet in accordance with an aspect of the disclosed embodiment.

### DETAILED DESCRIPTION

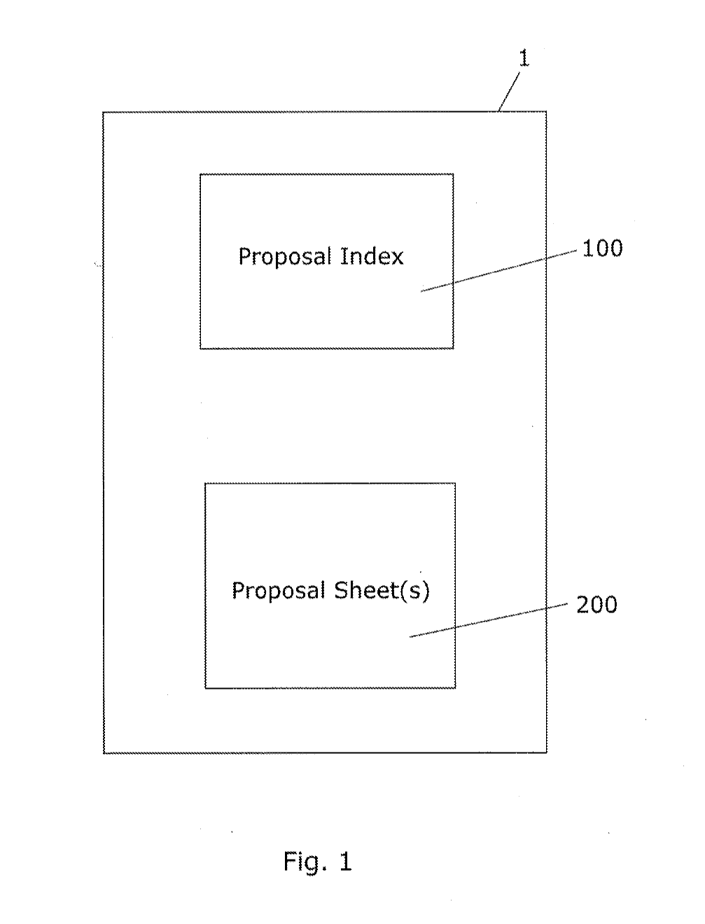

FIG. 1 illustrates a proposal booklet 1 in accordance with an aspect of the disclosed embodiment. Although the aspects of the disclosed embodiment will be described with reference to the drawings, it should be understood that the aspects of the disclosed embodiment can be embodied in many forms. In addition, any suitable size, shape or type of elements or materials could be used.

According to the aspects of the disclosed embodiment, a proposal booklet 1 for identifying proposed repairs for a proposed renovation or repair project is provided. Referring to FIG. 1, proposal booklet 1 includes a proposal index 100 and at least one proposal sheet 200. The proposal booklet 1 in accordance with aspects of the disclosed embodiment provides a simple way to calculate a cost estimate for the proposal of each repair or renovation project. The proposal booklet 1 may be used as a presentation and a sales aid device in addition to being an aid for calculating the costs of a proposed repair or renovation project. The proposal booklet 1 may also explain a number of problems that a customer may be facing for a proposed repair or renovation project. Further, the proposal booklet 1 may also contain detailed descriptions of solutions corresponding to each of the problems explained within the proposal booklet 1.

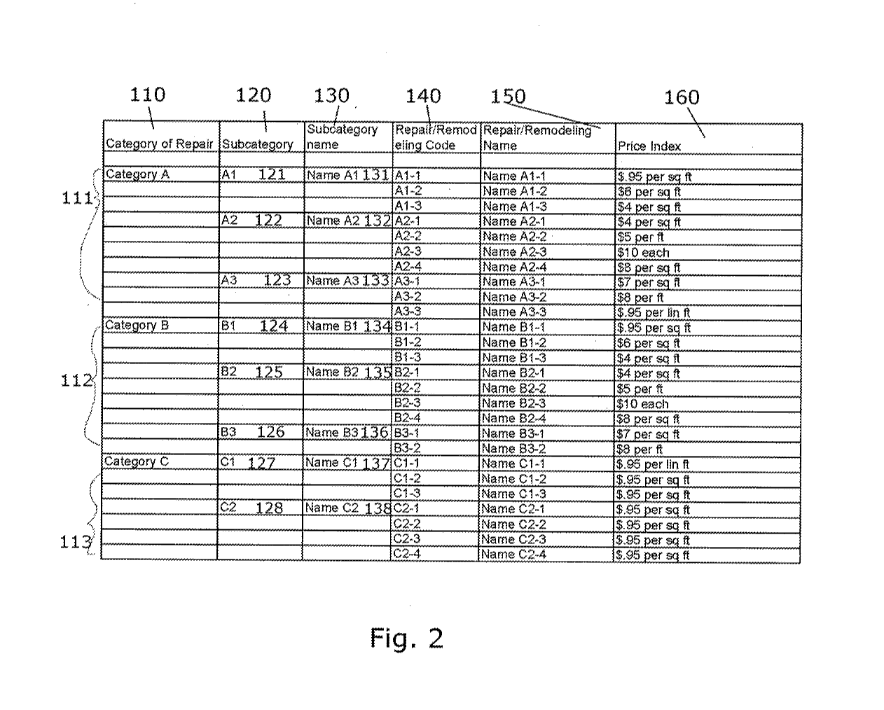

Referring to FIG. 2, the proposal index 100 is shown. The proposal index 100 may be presented as a matrix of services. The matrix of services shown in the proposal index 100 may include a listing of broad categories of repair 110, subcategories 120, subcategory names 130, repair codes 140, repair names 150 and a price index 160. The broad categories of repair 110 may list a number of project types. The project types may be related to attics, basements, insulations, or any other suitable broad category related to the field of repair or renovation of any suitable structure or site. These project types are shown as reference numbers 111-113 in FIG. 2. In other aspects, any suitable type of repairs or actions may be included in the group of project types.

The broad categories of repair 110 may be further broken down into subcategories 120. The listing of each subcategory may be a specific subset of actions or repairs for each of the project types 111-113. These specific subsets of actions or repairs may be denoted by reference numbers 121-128. In the example shown in FIG. 2, subcategories 121-123 are subcategories of broad category A, denoted by reference number 111. Each of the subcategories 120 may also be associated with a respective subcategory name 130. Each of the subcategory names 130, denoted by reference numbers 131-138, corresponds to a respective listing within subcategory 120 (i.e. subcategories 121-128). In the instance shown in FIG. 2, subcategory name 131 corresponds to subcategory 121, while subcategory name 132 corresponds to subcategory 122, and so on. As may be realized, one or more subcategory names 130 may correspond to a single subcategory 120.

Each of the subcategory names 130 may be further broken down to specific repair or renovation tasks represented by a repair code 140. Each of the entries of the repair code 140 represents a specific repair or remodeling task which corresponds to a respective subcategory name 130 entry, which in turn, corresponds to a respective subcategory 120 entry. In the example shown in FIG. 2, repair codes A1-1, A1-2 and A1-3 represent specific repair or remodeling tasks within subcategory name 131. In one aspect, there may be at least one repair code 140 entry associated with a respective subcategory 130 entry.

Further, each of the repair names represented within column 150 corresponds with a respective repair code 140. In the aspect shown in FIG. 2, the entry “Name A1-1” within repair name 150 corresponds to the entry “A1-” within repair code 140. In one aspect, one repair name 150 entry may be associated with each repair code 140 entry. In alternate aspects, any suitable number of repair name 150 entries may be associated with a repair code 140 entry. Each of the entries in repair names 150 has a respective price index 160 entry, w. In one aspect of the disclosed embodiment, the price index 160 entry describes the units of measure for a respective repair code 140 and repair name 150 entry as well as the unit price for each task. For example, in the aspect shown in FIG. 2. Repair code A1-1 is associated a price index of $0.95 per square feet, while repair code A2-1 has a price index of $4 per square feet. In alternate aspects, the unit of measure within price index 160 may be any suitable unit of measure including, but not limited to, square feet, linear feet, cubic feet, square meters, linear meters, cubic meters or gallons. In yet other aspects of the disclosed embodiment, the unit of measure within price index 160 may also list an absolute price (i.e. a price index of “$10.00 each”).

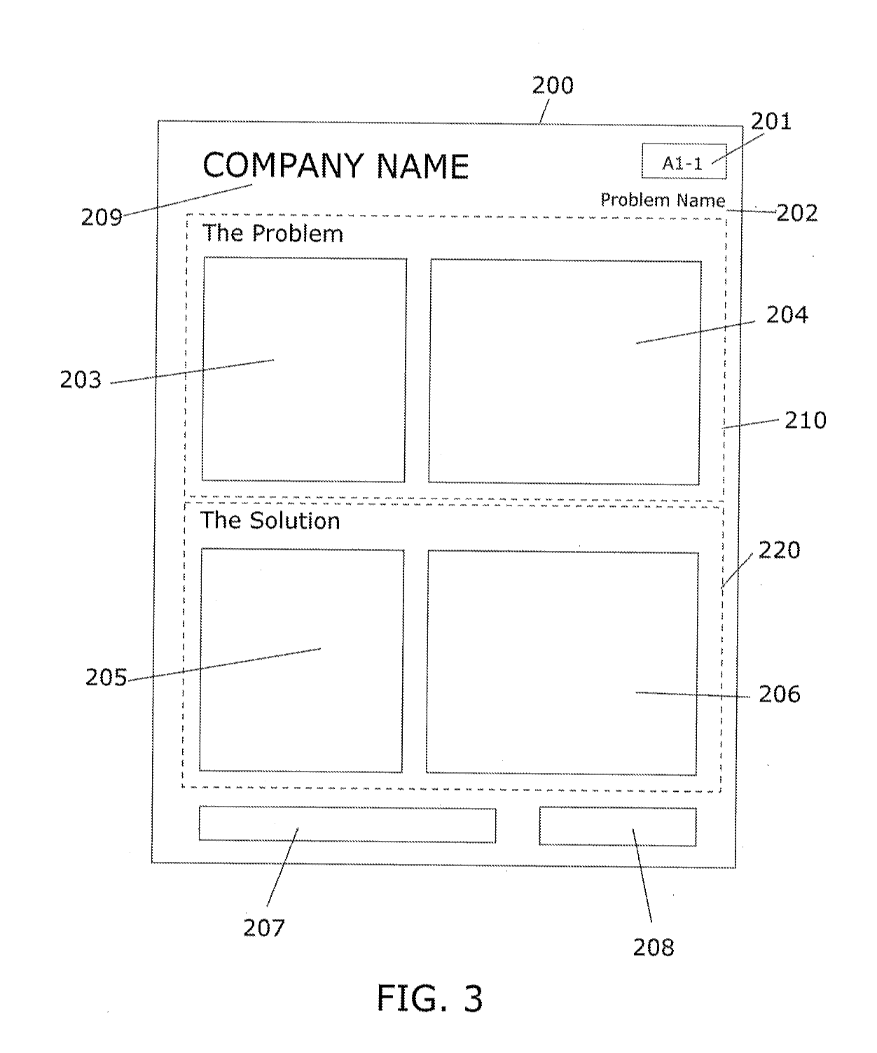

Referring now to FIG. 3, a proposal sheet 200 is shown. The proposal sheet 200 may be presented to illustrate a problem as well as a solution to the problem. The proposal sheet 200 may have a listing of the company name 209. The proposal sheet 200 may also include a repair code 201. The repair code 201 may correspond to one of the entries in repair codes 140 listed within the proposal index 100 shown in FIG. 2. In one aspect of the disclosed embodiment, there is at least one proposal sheet 200 for each of the repair codes 140 listed within proposal index 100 shown on FIG. 2. In other aspects, there may be fewer proposal sheets 200 than the repair codes 140 listed in the proposal index 100. The order of the proposal sheets 200 presented within a booklet may be arranged in a sequential order according to the repair codes 201. The sequential order may correspond to the manner in which the repair codes 140 are listed within the proposal index 100. The proposal sheet 200 may also include a problem name 202. In one aspect of the disclosed embodiment, the problem name 202 may correspond to an entry in repair name 150 of FIG. 2. This entry in repair name 150 of FIG. 2 may, in turn, further correspond to a respective repair code 140 in FIG. 2 which may, in turn correspond to the repair code 201 presented on the proposal sheet 200. In alternate aspects, problem name 202 may present a more verbose version of the repair name 150 entry which corresponds to a respective repair code 140 entry in FIG. 2, which in turn, corresponds to the repair code 201.

The proposal sheet 200 of FIG. 3 may be broken into a problem section 210 and solution section 220. Problem section 210 details a description of a problem a customer or homeowner may be seeking repair or renovation to remedy. The problem section 210 may include a problem description 204. Problem description 204 may be a brief description of the problem that a homeowner or customer may be experiencing. In other aspects, the problem description 204 may also include a description of the effect of leaving the problem presented in problem description 204 unresolved. In one aspect of the disclosed embodiment, the problem section 210 may also include a problem diagram 203, which has a diagrammatic illustration of the problem a homeowner may be experiencing. The problem diagram 203 should correspond to the problem described within problem description 204. In alternate aspects, any suitable indicia used to describe or present a potential problem may be presented within problem section 210.

Corresponding to problem section 210 of FIG. 3 is solution section 220. The solution section 220 may be used to detail a fix or a solution for a problem detailed within the corresponding problem section 200. The solution section 220 may further have a solution description 206. Solution description 206 may be a brief description of what can be done to remedy the problem described within a corresponding problem section 210. The solution description 206 may also have a description of the result of repairing the problem described in problem section 210.

In one aspect of the disclosed embodiment, the problem section 210 and solution section 220 may appear on the same page of the proposal sheet 200. In alternate aspects, the problem section 210 and solution section 220 may appear on separate pages.

Referring still to FIG. 3, the proposal sheet 200 may also have a description of the unit of measure 207 which may be used to generate a proposal cost estimate. The unit of measure 207 may simply be a description of what is to be measured and what units are to be used for the measurement. The unit of measure may be in, for instance, square feet of flooring or linear feet of molding. In other aspects, any suitable units of measure may be used. The unit of measure 207 corresponds to the unit of measure used in the price index 160 in FIG. 2 corresponding to the repair code 201 listed on proposal sheet 200. The unit of measure 207 listed in proposal sheet 200 allows for quick cross referencing of costs between the proposal sheet 200 and index sheet 100.

Referring still to FIG. 3, proposal sheet 200 may include a web address 208. The web address 208 may link a customer to additional information online related to the problems described in the problem section 210 and solutions described in solution section 220. In other aspects, any suitable information may be provided for directing the customer to further information may be used, including, but not limited to, indicia such as bar codes or QR codes or electronic indicia such as NFC (near field communications) tiles.

The proposal booklet as disclosed above may be generated on the fly for customized proposal booklets. In one aspect, the proposal booklets may be generated by any suitable software which is capable of generating and printing the services for each proposal sheet and proposal index. In other aspects, software can update proposal index 100 with updated information with or without updating any of the proposal sheets 200. In yet other alternate aspects, software can generate custom proposal booklets for customers according to the areas of repairs they may require. For instance, the software may generate a proposal booklet, only comprising a limited set of broad categories as opposed to all broad categories, for instance, a proposal booklet which only relate to basement repair.

In accordance with one or more aspects of the disclosed embodiment, a project proposal booklet is provided. The project proposal booklet includes an index sheet having a proposal index thereon, the proposal index having a matrix of services, the matrix of services including at least one broad category of services, at least one specific service associated with a respective broad category of services, at least one specific service code and at least one price index, each of which are associated with a respective at least one specific service, at least one proposal sheet corresponding to one of the at least one specific service and the at least one specific service code associated with the one of the at least one specific service, the at least one proposal sheet includes a problem section having a description of a service problem, a solution section having a description of a solution to the service problem, and a unit of measure describing the units of measure used to calculate a solution cost, the unit measure section further corresponding to the specific price index associated with the one of the at least one specific service.

In accordance with one or more aspects of the disclosed embodiment, wherein the at least one proposal sheet further include a web address to an online resource associated with the at least one proposal sheet.

In accordance with one or more aspects of the disclosed embodiment, wherein the at least one broad category of services may be divided into at least one subcategory of services, each of the at least one subcategory of services being associated with at least one specific service.

In accordance with one or more aspects of the disclosed embodiment, wherein the specific price index is a unique cost measurement associated with the corresponding at least one specific service.

In accordance with one or more aspects of the disclosed embodiment, wherein the problem section further comprises an illustration of the service problem.

In accordance with one or more aspects of the disclosed embodiment, wherein the solution section further comprises an illustration of the solution to the service problem.

In accordance with one or more aspects of the disclosed embodiment, wherein the service problem describes an issue related to home repair and renovation.

In accordance with one or more aspects of the disclosed embodiment, wherein the at least one proposal sheet are arranged in a sequential order corresponding to the order of the at least one specific service within the matrix of services.

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of the appended claims. Further, the mere fact that different features are recited in mutually different dependent or independent claims does not indicate that a combination of these features cannot be advantageously used, such a combination remaining within the scope of the aspects of the invention.

What is claimed is:

1. A project proposal booklet comprising:
an index sheet having a proposal index thereon, the proposal index on each index sheet having a matrix of services, the matrix of services including
a first listing of more than one broad category of services comprising more than one different, broad category of service elements, each broad category of service element of the first listing of the more than one broad category of services separately representing a different one of the more than one broad category of services, and having a predetermined characteristic different from another broad category of service element of the first, listing of the more than one broad category of services and defining each different broad category of services represented by the broad category of service element,
a second listing of more than one specific services associated with a respective broad category of services comprising more than one different specific service elements, at least one of the more than one different specific service elements is associated with each of the more than one broad category of service elements so that each of the more than one broad category of service elements has at least one different respective specific service element associated therewith, each specific service element of the second listing of the more than one specific services separately representing a different one of the more than one specific service element, and having a predetermined characteristic different from another specific service element of the second listing of the more than one specific services and defining each different specific service represented by the specific service element, where each more than one broad category of service elements is provided on a common index sheet with the at least one of the more than one different specific service elements associated with each respective broad category of services, so that the common index sheet is common to the more than one broad category of service elements and the associated at least one of the more than one different specific service elements,
at least one specific service code and at least one price index, each of which are associated with a respective specific service element; and
more than one proposal sheets corresponding to each of the more than one different specific service elements of the second listing of the more than one specific service and the at least one specific service code associated with the respective specific service element,
the more than one proposal sheet includes
a problem section having a description of a service problem,
a solution section having a description of a solution to the service problem, and
a unit of measure section describing the units of measure used to calculate a solution cost, the unit of measure section further corresponding to the at least one price index associated with the respective specific service element.

2. The project proposal booklet of claim 1, wherein the more than one proposal sheets further include a web address to an online resource associated with the at least one proposal sheet.

3. The project proposal booklet of claim 1, wherein the first listing of the more than one broad category of services may be divided into a listing of at least one subcategory of services, each of the at least one subcategory of services being associated with at least one of the more than one specific service elements.

4. The project proposal booklet of claim 1, wherein each of the at least one price index is a unique cost measurement associated with the respective specific service element.

5. The project proposal booklet of claim 1, wherein the problem section further comprises an illustration of the service problem.

6. The project proposal booklet of claim 1, wherein the solution section further comprises an illustration of the solution to the service problem.

7. The project proposal booklet of claim 1, wherein the service problem describes an issue related to home repair and renovation.

8. The project proposal booklet of claim 1, wherein the more than one proposal sheets are arranged in a sequential order corresponding to an order of the more than one specific services within the matrix of services.
